(19) United States
(12) Patent Application Publication
(10) Pub. No.: US 2010/0304616 A1
(43) Pub. Date: Dec. 2, 2010

(54) WIRING PROCESS AND WIRING ASSEMBLY OF CABLE CONNECTOR

(75) Inventors: Chun-Hsu CHEN, Chung Ho City (TW); Chun-Hua Chen, Chung Ho City (TW)

Correspondence Address: HDLS IPR Services, PO Box 220746, Chantilly, VA, 20153, US

(73) Assignee: JESS-LINK PRODUCTS CO., LTD.

(21) Appl. No.: 12/777,341

(22) Filed: May 11, 2010

(30) Foreign Application Priority Data
May 27, 2009 (TW) 098117616

(51) Int. Cl. H01R 24/00; H01R 43/16

(52) U.S. Cl. 439/660; 29/874

(57) ABSTRACT

A wiring process of a cable connector includes the steps of: providing a cable and a wiring assembly for the cable connector, the wiring assembly having a wiring body and a wiring plate; inserting naked ends of each cable core extending from the distal end of the cable into wiring ports of the wiring plate separately; and assembling the wiring plate with the wiring body to form the wiring assembly, thereby completing the wiring process.

### BACKGROUND OF THE INVENTION

1. Field of the Invention

The present invention relates to a connector, and in particular to a wiring process and a wiring assembly of a cable connector.

2. Description of Prior Art

As shown in FIG. 1, in a conventional cable connector, an insulating body 1a and a cable 3a are connected via a wiring assembly 2a by putting naked ends 300a of cable cores 30a in the cable 3a separately at corresponding positions of the insulating body 1a. In this way, a soldering process or electrical connection can be performed easily. Further, some cable cores 30a may comprise two or more wires 31a, 32a and 33a that are covered by an insulating layer separately. The wiring assembly 2a is provided with a plurality of troughs 20a for allowing the wires 31a, 32a and 33a of each cable core 30a to be embedded therein. Thus, the short circuit caused by the possible contact of the naked ends 300a can be prevented.

However, in such a wiring assembly 2a of the cable connector, the trough 20a is not provided with any distinguishable or recognizable shape or indicator. As a result, when an operator intends to embed the naked ends 300a of each cable core 300a into the troughs 20a, the operator may make mistake because he/she get confused by a great amount of naked ends 300a. Thus, the operator may embed some naked end 300a into a wrong trough 20a easily, which makes the wiring procedure difficult and incorrect. Further, since the naked ends 300a have a certain length, it is difficult for the operator to embed all the naked ends 300a into the wiring assembly 2a in one time.

### SUMMARY OF THE INVENTION

The present invention is to provide a wiring process and a wiring assembly of a cable connector. Due to its improved structure, the operator can disposed respective naked ends of the cable in correct positions separately. It is not necessary for the operator to embed all the naked ends into the wiring assembly in one time. Thus, the mistake made in performing the wiring process can be reduced and the assembling process can be performed more easily and correctly.

The present invention is to provide a wiring process of a cable connector, which includes the steps of:

a) providing a cable, a wiring body and a wiring plate, wherein the wiring body and the wiring plate are in a separate status;

b) embedding naked ends of cable into wiring ports of the wiring plate separately; and

c) assembling the wiring plate with the wiring body to form a single assembly.

The present invention is to provide a wiring assembly of a cable connector, which includes a wiring plate and a wiring body. The upper and lower edges of the wiring plate are provided with a plurality of wiring ports. The wiring body is assembled with the wiring plate. A detachable mechanism is provided between the wiring plate and the wiring body, so that the front end face of the wiring plate can be overlapped on the rear end face of the wiring body to form a single unit. By this arrangement, the wiring assembly of a cable connector can be obtained.

### BRIEF DESCRIPTION OF THE DRAWINGS

FIG. 1 is an exploded view showing the wiring assembly of the cable connector in prior art;

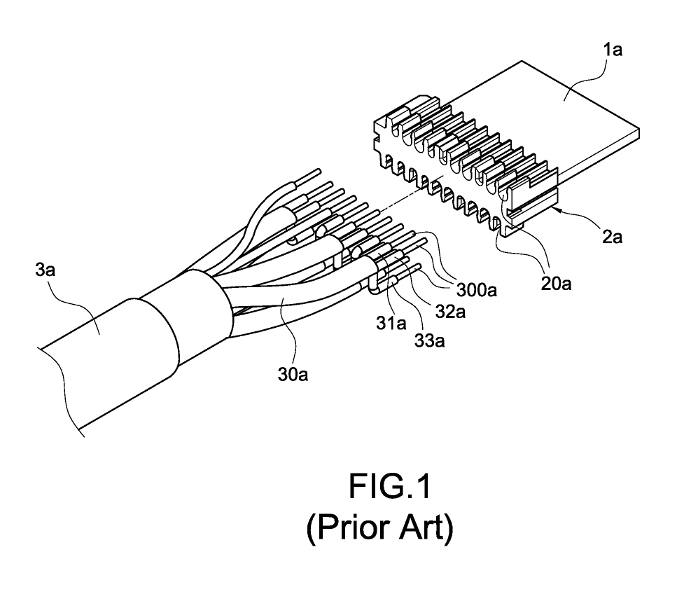

FIG. 2 is a flow chart showing the steps of the present invention;

FIG. 3 is an exploded perspective view showing the cable connector of the present invention;

FIG. 4 is a schematic view showing the action in the step S2 of FIG. 2;

FIG. 5 is a schematic view showing the action in the step S3 of FIG. 2; and

FIG. 6 is an assembled perspective view showing the cable connector of the present invention.

### DETAILED DESCRIPTION OF THE INVENTION

In order to make the Examiner better understand the characteristics and technical contents of the present invention, a description relating thereto will be explained with reference to the accompanying drawings. However, the drawings are illustrative only but not used to limit the present invention.

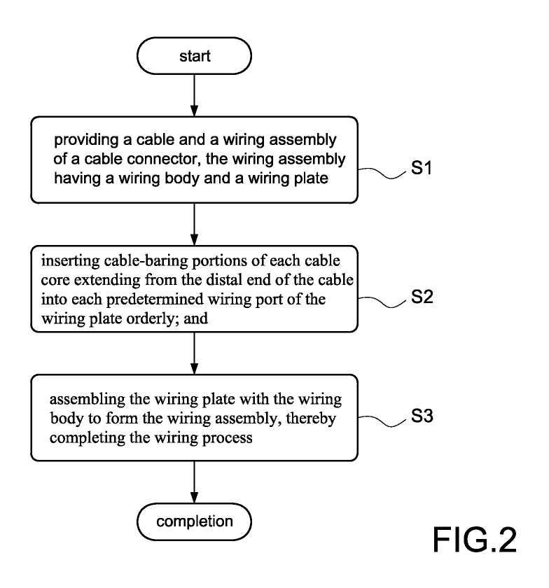

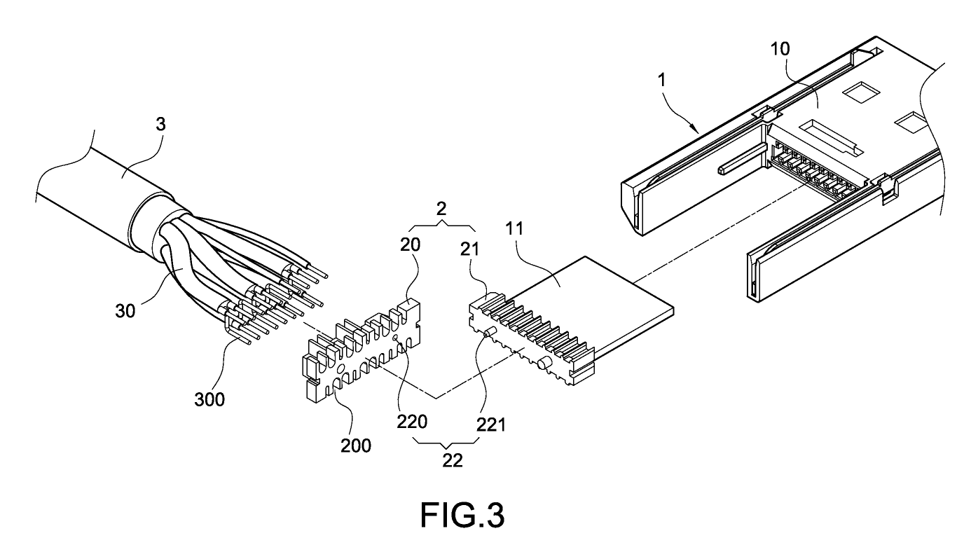

The present invention provides a wiring process and a wiring assembly of a cable connector. Please refer to the step S1 in FIG. 2 and also refer to FIG. 3. First, a cable 3 and a wiring assembly 2 of a cable connector are provided. The wiring assembly 2 comprises a wiring body 21 and a wiring plate 20 that are detachably assembled with each other. The cable connector further includes a connecting head 1. The connecting head 1 comprises a casing 10 and an insulating body 11 provided in the casing 10. The insulating body 11 is connected to the wiring body 21 of the wiring assembly 2, so that all these components can be assembled in the casing 10. Further, a detachable mechanism 22 is provided between the wiring plate 20 and the wiring body 21 of the wiring assembly 2. The detachable mechanism 22 is composed of two insertion holes 220 on the front end face of the wiring plate 20 and two corresponding insertion pins 221 on the rear end surface of the wiring body 21. After the insertion pins 221 insert into the insertion holes 220, the front end face of the wiring plate 20 touches the rear end face of the wiring body 21, thereby forming a detachable assembly. By means of the detachable assembly, the wiring plate 20 can dovetail with the wiring body 21. Of course, the positions of the insertion holes 220 and the insertion pins 221 can be exchanged.

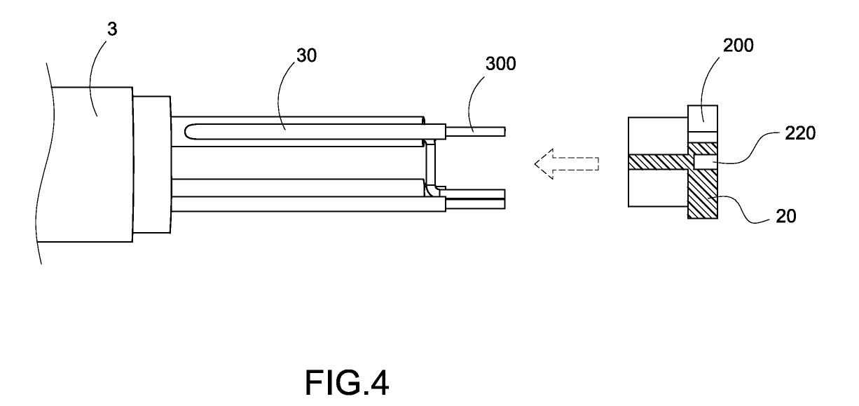

Next, please refer to the step S2 in FIG. 2 and also refer to FIG. 4. Naked ends 300 of each cable core 30 of the cable 3 are separately embedded into wiring ports 200 provided on the upper and lower edges of the wiring plate 20. Thus, the operator can make the originally-disordered cable cores 30 in order.

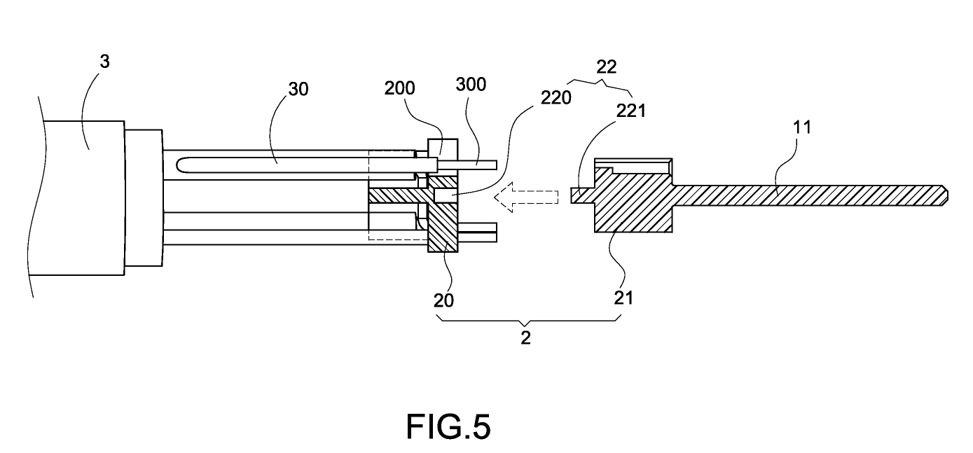

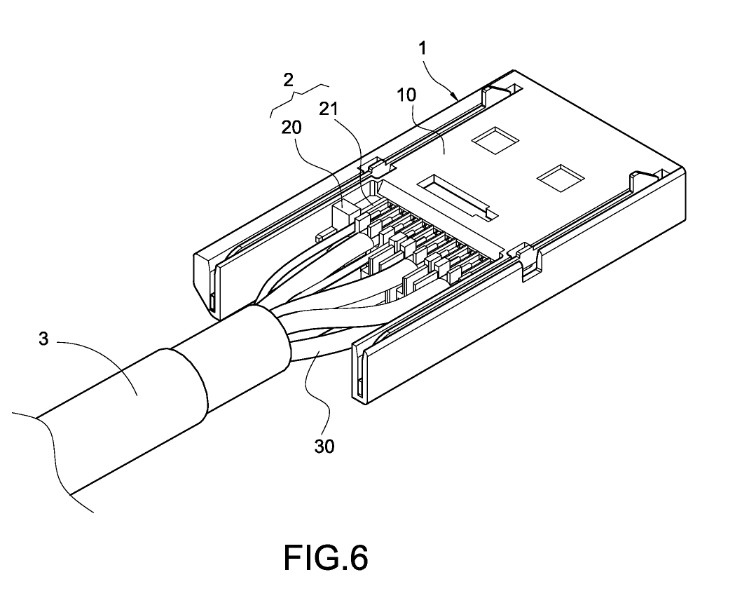

Please refer to the step S3 in FIG. 2 and also refer to FIG. 5. The wiring plate 20 is assembled with the wiring body 21 to form the wiring assembly 2. That is, via the detachable mechanism 22 between the wiring plate 20 and the wiring body 21, the wiring plate 20 can be assembled on the rear end face of the wiring body 21. Since the respective cable cores 30 of the cable 3 are put in order after the step S2, the length of each naked end 300 is partially embedded into the wiring plate 20. As a result, the remaining part of each naked end 300 can be disposed on the wiring body 21 more easily and correctly. Thus, the wiring process can be completed. Then, the terminals in the casing 10 can be soldered to generate electrical connection (FIG. 6).

Via the above arrangement, the wiring process and the wiring assembly of a cable connector according to the present invention can be obtained.

According to the above, the present invention really achieves the expected objects and solves the problems of prior art. Further, the present invention demonstrates novelty and inventive steps, which conforms to the requirements for an invention patent.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A wiring process of a cable connector, comprising the steps of:
a) providing a cable, a wiring body and a wiring plate, wherein the wiring body and the wiring plate are in a separate status;
b) embedding naked ends of the cable into wiring ports of the wiring plate separately; and
c) assembling the wiring plate with the wiring body to form a single assembly.

2. The wiring process of a cable connector according to claim 1, wherein the wiring plate is detachably assembled with the wiring body.

3. The wiring process of a cable connector according to claim 2, wherein the wiring plate is provided with insertion holes, the wiring body is provided with corresponding insertion pins, the insertion pins are inserted into the insertion hole to form a detachable assembly.

4. A wiring assembly of a cable connector, comprising;
a wiring plate with its upper and lower edges provided with a plurality of wiring ports; and
a wiring body assembled with the wiring plate;
wherein a detachable mechanism is provided between the wiring plate and the wiring body, so that the wiring plate is combined with the wiring body to form a single unit.

5. The wiring assembly of a cable connector according to claim 4, wherein the detachable mechanism comprises insertion holes on a front end face of the wiring plate and corresponding insertion pins on a rear end face of the wiring body.
